(19) United States
(12) Patent Application Publication
(10) Pub. No.: US 2021/0024296 A1
(43) Pub. Date: Jan. 28, 2021

(54) SEALING ARRANGEMENT FOR IDLER ROLLERS USED IN WEIGHING ROLLER BELTS

(71) Applicant: CONTROL SYSTEMS TECHNOLOGY PTY LTD, Revesby (AU)

(72) Inventor: Paul Evan Lillington, Revesby (AU)

(21) Appl. No.: 17/045,164

(22) PCT Filed: Apr. 4, 2019
(86) PCT No.: PCT/AU2019/050292

§ 371 Date: Oct. 3, 2020

(30) Foreign Application Priority Data
Apr. 6, 2018 (AU) 2018901138

(51) Int. Cl. B65G 39/09; B65G 39/12; G01G 11/04; G01G 23/37; B65G 39/20

(52) U.S. Cl. CPC B65G 39/09; B65G 39/12; B65G 39/20; G01G 23/3735; G01G 11/043

(57) ABSTRACT

Disclosed in one example is an idler roller for a conveyor belt weighing system, comprising a static shaft, and a load cell fixed to the static shaft and positioned at least partially internal to the static shaft and at an end of the static shaft, the load cell for supporting the idler roller on a frame. A rotating shaft seal is positioned on an exterior surface of the static shaft and internal to the idler roller. A static seal is positioned between the load cell and an interior surface of the static shaft. The static shaft includes a first pocket into which the load cell is inserted and fixed, the static shaft also includes a second pocket into which the load cell is inserted and fixed. The load cell includes one or more strain gauges, and the load cell is rigidly fixed in the end of the static shaft.

### TECHNICAL FIELD

The present invention generally relates to the field of conveyor belt weighing systems (i.e. weighing roller belts). More particularly, the present invention relates to idler rollers used in conveyor belt weighing systems.

### BACKGROUND

There have been various approaches in attempting to develop reliable and accurate conveyor belt weighing systems. Accurate motion weighing equipment is required for bulk handling of materials in many diverse industries, for example in mining, ship loading, rail loading, grain, coal power, quarry, food industries, etc. Conveyor belt weighing systems are used to handle materials in many diverse fields ranging from mining to food and feed production. The conveyor belts are typically used to transport materials from a first area to a second area. Often the material transported by the conveyor belt must be weighed. This enables the amount of material delivered to the second area to be monitored. Conveyor belts typically comprise a plurality of idler rollers provided intermediate to a driven roller and a following roller to support the conveyor belt and the materials transported thereon, and to limit sag of the conveyor belt. The longer the span and the heavier the materials being supported on the conveyor belt the more idler rollers that are provided.

In order to weigh the material while on the conveyor belt it is preferable to weigh the materials on the conveyor belt at a location away from either end of the conveyor belt. It is preferable not to take weight measurements at or near to either the driven roller or the following roller due to the sudden changes in loads often experienced at these locations. It is generally accepted practice to measure the weight of materials passing over a conveyor belt at a point between the driven roller and the following roller.

In order to weigh the materials it is common practice to disconnect an entire idler roller assembly from the frame of the conveyor, mount a sub-frame having load cells onto the conveyor frame, and support the entire idler roller assembly on the load cells supported by the sub-frame.

There are however some problems with known weighing solutions. First of all, the known weighing systems are relatively time consuming to install. Typically, an idler roller assembly must be removed from the conveyor frame, holes must then be drilled into the conveyor belt frame, and a sub-frame must then be mounted on the conveyor belt frame before the idler roller assembly is mounted on the sub-frame. Once in position, the next adjacent pair of idler rollers, one either side of the assembly of weighing idler rollers, and in some cases two idler rollers either side of the assembly of weighing idler rollers, must be shimmed so that the three (or in some cases more) idler rollers are substantially in line with each other to ensure accurate weight measurements. This is time consuming to perform and during which time the conveyor belt will be out of operation often resulting in lost revenue. Another problem with known solutions is that components, in particular the load cells, are susceptible to damage caused by materials falling from the conveyor belt and accuracy of measurement can be diminished by build-up of materials on the load cells.

Referring to FIG. 1 (prior art) by way of example, there is illustrated a known conventional fully suspended weigh frame 110 forming part of a conveyor belt weighing system 100. Conveyor belt weighing system 100 includes idler rollers 120 spaced apart to support belt 130. Idler rollers 140 are part of fully suspended weigh frame 110. Conveyed material being transported along conveyor belt 130 imparts its weight via conveyor belt 130 and idler rollers 140 and can be measured by weigh frame 110. A fully suspended weigh frame has the property that if an idler roller mounted on the weigh frame were to jamb then the resulting frictional force in line with the conveyor belt would have practically no effect on the output weight signal. Also, the normal idler roller rolling friction, nominally 2 to 3% of the load on the conveyor belt, is not reflected in the output weight signal from the weigh frame. In a fully suspended weigh frame, weight applied at any location on the weigh frame will produce the same output weight signal. Such designs are only sensitive to loads perpendicular to the conveyor belt.

Referring to FIG. 2 (prior art) by way of further example, there is illustrated an isometric view of a known conveyor belt weighing system 200 (the belt not being illustrated). Conveyor belt weighing system 200 includes a fully suspended weigh frame 210, including a plurality of spaced idler rollers 220. Idler rollers 220 are used throughout the conveyor section illustrated and support a conveyor belt in relation to the fully suspended weigh frame 210. Winged support components 230 can also be provided.

There is a need for new or improved conveyor belt weighing systems, and/or idler rollers used in conveyor belt weighing systems (i.e. weighing roller belts), which address or at least ameliorate one or more problems in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### SUMMARY

In one example form, the present invention provides a conveyor belt weighing system. In another form, the present invention provides an idler roller used in a conveyor belt weighing system (i.e. weighing roller belts). In another form, the present invention provides a sealing arrangement for an idler roller, the idler roller used in a conveyor belt weighing system. In another form, the idler roller comprises at least one load cell and is able to measure the weight of material passing over the idler roller.

In another example form there is provided an idler roller for a conveyor belt weighing system, comprising: a static shaft; a load cell fixed to the static shaft and positioned at least partially internal to the static shaft and at an end of the static shaft, the load cell for supporting the idler roller on a frame; and a rotating shaft seal positioned on an exterior surface of the static shaft and internal to the idler roller.

In another example form there is provided a conveyor belt weighing system, comprising: one or more of the idler rollers; a plurality of standard idler rollers; a frame supporting the one or more idler rollers and the plurality of standard idler rollers; and a conveyor belt supported by the one or more idler rollers and the plurality of standard idler rollers.

In another example form there is provided an idler roller for a conveyor belt weighing system, comprising: a static shaft; and two load cells fixed to the static shaft; wherein each of the two load cells produces an analogue signal and is connected to an analogue to digital converter that produces a digital output representing the analogue signal.

In another example form there is provided a plurality of idler rollers for a conveyor belt weighing system, comprising at least a first idler roller and at least a second idler roller, wherein the plurality of idler rollers wirelessly communicate and/or optically communicate to each other to form a cluster of active idler rollers which act as one device.

Example embodiments of the present invention relate to positioning and/or sealing of at least one load cell in an idler roller, where material to be weighed is transported by a conveyer belt supported, at least in part, by the idler roller.

### BRIEF DESCRIPTION OF FIGURES

Example embodiments are provided in the following description, which is given by way of example only, of at least one preferred but non-limiting embodiment, described in connection with the accompanying figures.

FIG. 1 (prior art) illustrates a conventional fully suspended weigh frame having idler rollers.

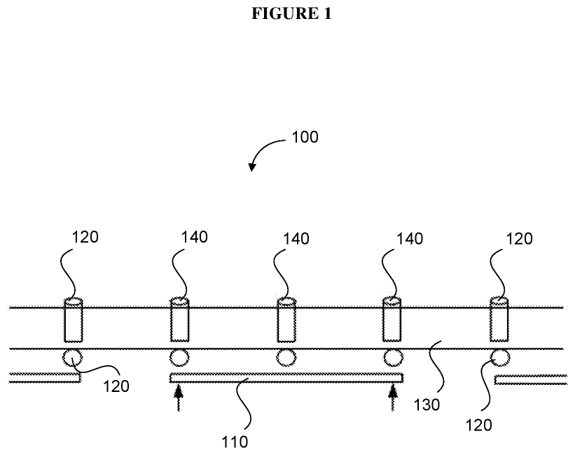

FIG. 2 (prior art) illustrates an isometric view of a known conveyor belt weighing system (the conveyor belt not illustrated).

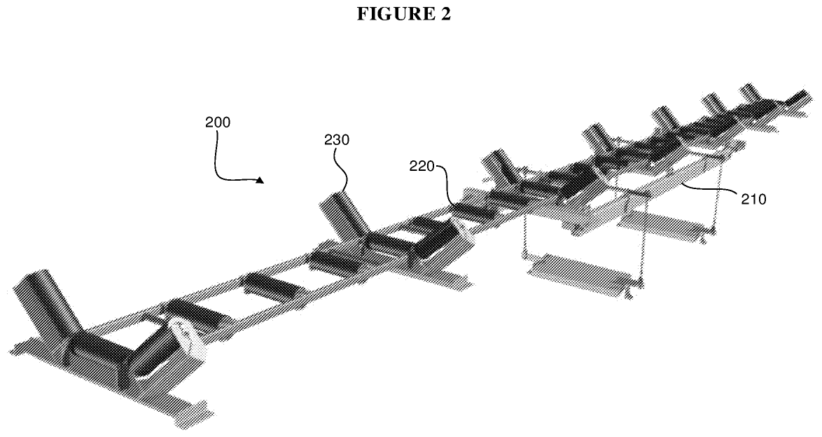

FIG. 3 illustrates a longitudinal cross-section plan view of one end of an example idler roller, showing an example sealing arrangement for a load cell.

FIG. 4 illustrates an example load cell.

FIG. 5 illustrates a portion of an example conveyer belt weighing system.

FIG. 6 illustrates a further example of a conveyer belt weighing system.

FIG. 7 illustrates a further example of a conveyer belt weighing system.

FIG. 8 illustrates a further example of a conveyer belt weighing system.

FIG. 9 illustrates an internal view of an example weighing idler roller.

FIG. 10 illustrates a cross-sectional view of another example weighing idler roller.

### PREFERRED EMBODIMENTS

The following modes, given by way of example only, are described in order to provide a more precise understanding of the subject matter of a preferred embodiment or embodiments.

In one example an idler roller has been designed to be able to receive a load cell inserted inside an end of a single shaft of the idler roller, preferably the single shaft is cylindrical, instead of the load cell being positioned between a bearing assembly and the supports or the frame. In an example two load cells can be separately inserted inside each of the two ends of a single shaft of the idler roller. This arrangement provides improved rigidity and better load cell clamping. The arrangement also allows the bearing to be placed in the same position as a standard conveyer belt idler roller. The arrangement also allows for the use of standard shafts for the bearing. In the present embodiments, loads (i.e. weight forces) are not transmitted to the load cell from bending of the shaft of the idler roller, or the shell of the idler roller, or a mechanical seal. This provides higher accuracy and reliability of weight measurements of material transported by a conveyor belt supported by the idler roller.

In one example there is provided an idler roller with at least one internal load cell which is able to measure the weight of material passing over the idler roller. Preferably, the idler roller comprises a shaft with two load cells embedded or inserted into the shaft, one load cell embedded or inserted at each end of the shaft of the idler roller. The shaft, preferably a round or cylindrical shaft, is of sufficient strength to reduce the deflection of the shaft at a bearing support point, thereby preventing excessive deflection that would otherwise reduce the life of the bearing. The shaft is preferably a single shaft formed as a cylinder or a pipe with at least one internal pocket, or at least one internal recess, provided at each end of the shaft, which can otherwise be solid along the rest of the shaft.

Placement of the load cell inside, or at least partially internal to, or internal to, the shaft of the idler roller protects the load cell from damage. The shaft is static, that is fixed relative to a frame, and a rotating shaft seal, for example a soft silicon seal, prevents or reduces ingress of moisture (i.e. water) and/or dirt into a strain gauge area of the load cell. The rotating shaft seal material should be soft enough, or suitably elastic or pliable or flexible or malleable, so as to not interfere with sensitivity of or measurements by the load cell. The rotating shaft seal should be protected against mechanical damage. In one embodiment this is achieved by positioning the rotating shaft seal in or near an end of a pocket of the shaft, where the rotating shaft seal is protected from mechanical damage.

It is also preferable that two load cells, when used, one at each end of the idler roller, be exactly vertical. This can be achieved by placing the shaft with load cells fitted in a jig before mechanically fixing, bolting or adhering the load cells in position in the shaft of the idler roller.

Example embodiments allow for accurate orientation of the load cells. Poor clamping of a load cell can affect load cell accuracy and reliability. A load cell is rigidly fixed in an end of the shaft, thus eliminating or reducing any errors caused by poor clamping. A separate mechanical shaft seal positioned between moving parts is not required to seal dirt and moisture from the load cell itself, as the load cell is positioned inside the shaft and is fixed to the static shaft, thus the load cell is also static. A static seal can be provided between the body of the static load cell and the static shaft, however any such additional static seal is between components that are fixed in position relative to each other, not between moving components. This also means that any forces caused by such an additional static seal are not detected by or transferred to the load cell inside the shaft as they are fixed in position relative to each other. The shaft is preferably made of a metal, an alloy or a composite material.

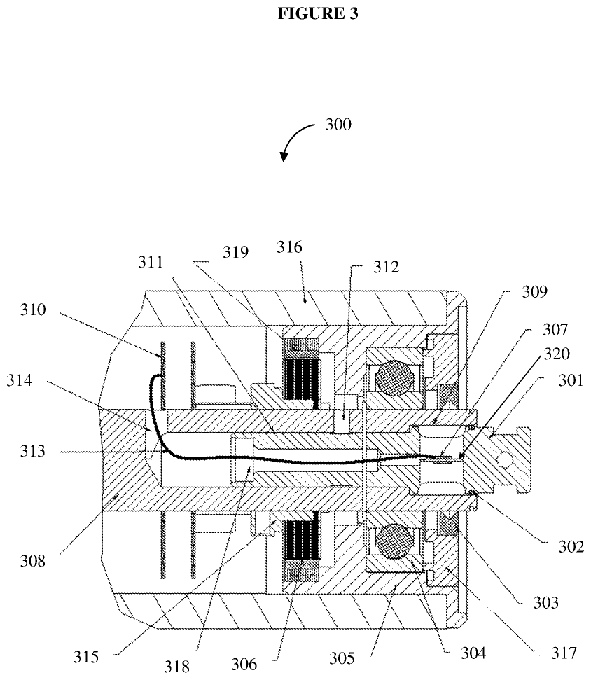

Referring to FIG. 3, there is illustrated a longitudinal (i.e. along the longitudinal axis) cross-section plan view of an end region of an example idler roller 300. A static shaft 308 is provided with first pocket (or first recess) 309 and second pocket (or second recess) 311, preferably by being machined into static shaft 308. A load cell 301 is inserted into static shaft 308 and into first pocket 309 and second pocket 311. One or more strain gauges 307, for example two strain gauges 307, are fixed, bonded, attached or adhered to a waist section 320 of the body of load cell 301. The waist section can be a narrowed section of the body of load cell 301 and is a weakened section. The art refers to this portion of a load cell as the ‘web’. A web is a narrow portion of the load cell that will elastically deform under the application of external loads. Ideally this deformation will have a linear relationship between the applied load and the derived signal gained from an applied strain gauge. Elastic deformation, as known in the art, is when the original shape of the web is restored upon the removal of the load. Care in design is taken to ensure a permanent deformation does not occur wherein a plastic deformation of the web occurs from the applications of excess load.

It should be appreciated that the opposite end of idler roller 300 (not illustrated) can be the same as, and have the same components as, for example including a second load cell and associated components, the end of idler roller 300 as is illustrated in FIG. 3.

The waist section of the body 320 of load cell 301 is positioned or contained within first pocket 309, which has a clearance to allow deflection of an end of load cell 301. A static seal 302, for example a static sealing ring, which is preferably a soft sealing ring, seals the one or more strain gauges 307 from the ingress of moisture and dirt. Static seal 302 does not transfer any forces to load cell 301 inside static shaft 308 as they are fixed in position relative to each other. A rotating shaft seal 303 is placed outside of static shaft 308 in the vicinity of, or within the longitudinal extent of, pocket 309, and inside idler roller 300 such that rotating shaft seal 303 is protected from damage.

Load cell 301 is fixed to static shaft 308 and is positioned at least partially internal to static shaft 308 and at an end of static shaft 308. Load cell 301 is for supporting idler roller 300 on a frame. Rotating shaft seal 303 is positioned on an exterior surface of static shaft 308 and internal to idler roller 300, for example being inside of an end plate of idler roller 300. Static seal 302 is positioned between load cell 301 and an interior surface of static shaft 308. In one example, rotating shaft seal 308 is positioned within the longitudinal extent of first pocket 309. In one example, rotating shaft seal 308 is positioned within the longitudinal extent of the waist section of the body of load cell 301. In one example, static seal 302 is positioned outside the longitudinal extent of the waist section of the body 320 of load cell 301. In one example, static seal 302 is positioned closer to an end of static shaft 308 than the rotating shaft seal 303.

Rotating shaft seal 303 may be located on the inside of the shaft bearing 304 and is not bound to be located over pocket 309.

Load cell 301 is fixed securely into second pocket 311, for example by adhesive, or by being mechanically attached or fixed. For example load cell 301 can be held in place with a screw inserted through hole 312, separately or additionally with an adhesive, or for example until adhesive, if being used, has hardened after which the screw might be optionally removed. Example adhesives include those based on acrylic, cyanoacrylate, epoxy, hot melt, silicone and urethane. A plurality of screws, such as that inserted through hole 312, may be used such that a mechanical bond between load cell 301 and second pocket 311 can be made without the use of adhesives. This renders the weighing roll serviceable to the a level where load cells can be replaced.

Rotating shaft seal 303 is positioned on or near an end of shaft 308, and any bending loads caused by rotating shaft seal 303 are not measured by load cell 301 inserted inside static shaft 308. The forces on roller shell 316, from material passing over idler roller 300, are transmitted directly to load cell 301 through bearing 304, with no added forces arising from rotating shaft seal 303. Roller shell 316 is rotatable about static shaft 308.

An electronics board 310, positioned internal to idler roller 300 or internal of roller shell 316, which is used to take readings from one or more strain gauges 307, is connected by wires 313 through holes 314 in static shaft 308 and holes 318 in the body of load cell 301.

Electronics board 310 is mounted on flange 315, which can be machined, and which is used to fix both a permanent magnet generator 306 and the electronics board 310 to static shaft 308. Permanent magnet generator 306 and electronics board 310 are internal to idler roller 300. A bearing housing 305 has shell 316 fixed to it and also contains bearing 304. The rotor of generator 319 is fixed to bearing housing 305. The stator of permanent magnet generator 306 is fixed to the shaft 308. This arrangement provides reliable and accurate tachometer readings from generator 306. The one or more strain gauges 307 are located internal to static shaft 308. Bearing retainer 317 is snapped into bearing housing 305.

In another example, the generator is provided with magnets bonded in a steel ring to prevent flux leakage on the outer shell. This leakage could otherwise cause the idler roller to pick up metallic or iron particles and clog the idler roller. A larger generator can be used without producing cogging torque. A permanent magnet generator is provided to supply the electrical power needed by the internal electronics. A combination of magnets and stator poles (for example, preferably 22 magnets and 27 slots stator in one embodiment) is preferred. This reduces or eliminates the cogging torque which reduces the chances of belt slip. A conventional laminated iron stator can be used. This reduces the cost and size for a given output power and increases the efficiency of the generator. In one example, the idler roller, for a conveyor belt weighing system, thus includes a generator and power, e.g. power waves, from the generator can be used to derive a tachometer computation.

By providing idler roller 300 the installation of a weighing idler roller is significantly simplified. For example, instead of removing an entire idler roller assembly and mounting the idler roller assembly onto a sub-frame with load cells, an existing idler roller (or for example a centre idler roller if the idler roller assembly comprises a centre idler roller and a pair of side or wing idler rollers) can be removed from the existing idler roller assembly and replaced by the present embodiment idler roller. The load cell 301 mounted in static shaft 308 internal to rotatable roller shell 316 permits the weight of the materials on the conveyor belt above the idler roller to be weighed with accuracy. No additional sub-frame is required and it is not necessary to drill into the conveyor belt frame.

Furthermore, due to the sealing arrangement provided and as load cell 301 is located internal to idler roller 300, and at least partially internal to static shaft 308, this additionally protects load cell 301, particularly one or more strain gauges 307, from damage caused by materials that may fall from the conveyor belt and there will not be a tendency for degradation in performance caused by material build up on or around load cell 301. Furthermore, the idler roller and sealing arrangement provided protects against moisture ingress and any degradation in components that would otherwise occur due to moisture.

Examples of the present idler roller are used as part of a conveyor belt weighing system that also includes multiple spaced conventional (non-weighing) idler rollers for normal use in supporting material transported on the conveyor belt. The present “weighing idler rollers” can replace one or more known conventional (non-weighing) idler rollers. One or more winged idler rollers, for example idler rollers placed at an angle to a base or middle idler roller, can be provided as, optionally, either a weighing idler roller or as a conventional (non-weighing) idler roller.

In one example, a static seal is positioned between the load cell and an interior surface of the static shaft. In another example, the static shaft includes an internal first pocket into which the load cell is inserted and fixed. In another example, the static shaft also includes an internal second pocket into which the load cell is inserted and fixed. In another example, the load cell includes one or more strain gauges. In another example, the load cell is rigidly fixed in the end of the static shaft. In another example, the rotating shaft seal is positioned within the longitudinal extent of first pocket. In another example, the rotating shaft seal is positioned within a longitudinal extent of a waist section of a body of the load cell. In another example, the static seal is positioned outside a longitudinal extent of a waist section of a body of the load cell. In another example, the static seal is positioned closer to an end of the static shaft than the rotating shaft seal. In another example, a roller shell is rotatable about the static shaft.

In another example, an electronics board is positioned internal to the idler roller and takes readings from the one or more strain gauges. In another example, the one or more strain gauges are located internal to the static shaft. In another example, a permanent magnet generator is internal to the idler roller and fixed to the static shaft.

In further non-limiting examples the present idler roller can provide an autonomous weighing idler roller for process applications. The weighing idler roller can be self powered and optionally provided without external cables. Internal electronics can provide wireless connectivity, for example using Wi-Fi or Xbee wireless communication, and/or optical communication. Other features that can be provided by internal components and/or electronics include temperature monitoring, for example for compensation, a three-axis accelerometer, for example for compensation for orientation and vibration, a tachometer, which for example could be an independent wireless tachometer, and one or more internal processes for real-time weighing of transported material. An accurate load cell is provided for quality weight measurements.

In a further non-limiting example, a weighing idler roller can be self-powered using an internal generator. An example generator could be provided as an internal permanent magnet generator to supply power requirements for the weighing idler roller. The weighing idler roller must be allowed to turn freely and preferably a three-phase smooth permanent magnet generator can be utilised. Internal batteries can be provided, for example for a start-up phase of the weighing idler roller. Improved efficiency can be achieved for example by using a DC-DC converter design.

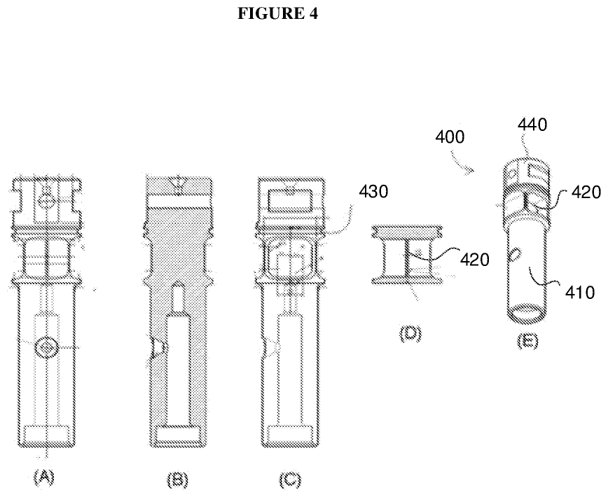

In further non-limiting examples, a load cell is inserted into an end of the static shaft that is hollow, bored out, or recessed, and the load cell detects forces perpendicular to the axis of the static shaft. The load cell is replaceable and is a mechanically shielded insert. An example load cell is illustrated in FIG. 4. FIG. 4A shows a plan view of an example load cell design. FIG. 4B shows an elevation cross-section along the longitudinal axis of the example load cell. FIG. 4C shows an elevation view of the example load cell. FIG. 4D shows a cross section of a plan view of a waist section of the body of the load cell. FIG. 4E shows an isometric view of the example load cell. Load cell 400 includes a cylindrical portion 410 and a waist section 420 which are inserted internally into an end of a static shaft of a weighing idler roller. Section 410 is received in an internal second pocket of the static shaft, and waist section 420 is received in an internal first pocket of the static shaft. The static seal is received in annular recess 430. Support section 440 is fixed to the frame, or sub-frame, of a conveyer belt weighing system. When one or more strain gauges are fixed in waist section 420, the load cell 400 is continuously powered and provides for continuous weight measurements. The load cell can have a circular outer casing providing a shaft with a sealing arrangement.

One or more printed circuit boards, for example a power supply printed circuit board and a processor and instrumentation printed circuit board, can be provided internal to a weighing idler roller. For example, the printed circuit boards can be provided in the shape of an annular disc that fits around the static shaft and are internal to a roller shell of the weighing idler roller. The power supply printed circuit board can include features such as three-phase AC in, and high efficiency DC out, a tachometer, a wake-up circuit, a stay powered-on feature, for example for when a conveyer belt is stopped for maintenance, and a battery to support initial start-up phase and maintenance access. The power supply printed circuit board can be mounted to, for example, the permanent magnet generator. The processor and instrumentation printed circuit board can include features such as on board memory, an accelerometer providing three-axis measurement, a temperature monitoring device, and one or more wireless communication devices, for example one or more Wi-Fi transmitters/receivers and/or one or more Xbee wireless transmitters/receivers (i.e. IEEE 802.15.4 based communication protocols used to create personal area networks with small, low-power digital radios).

Preferably, in one example, there are two active Wi-Fi interfaces provided for a weighing idler roller. A first Wi-Fi interface provides an ‘access point’ to which a computerised device, smart phone, tablet, computer, etc., may connect, and which provides communication/control via a user interface provided on the computerised device, smart phone, tablet, computer, etc. A second Wi-Fi interface provides a ‘station’ mode which can search for another external access point, preferably a customer's or user's access point, to connect with which is part of the customer's or user's network. The second Wi-Fi is preferably, but not necessarily, configured with access point SSID, user's name and password, and can automatically connect. The second Wi-Fi connection can be used for Modbus TCP over IP data to a Digital Control System (DCS). Optionally, the second Wi-Fi may also support a remote user interface. The first Wi-Fi interface effectively acts as a connect in, and the second Wi-Fi interface effectively acts as a connect out. The second Wi-Fi interface, providing the connect out or ‘station’ mode, looks to permanently connect to the customer's or user's network, for example an industrial computer system, to provide a permanent data source and/or data store.

The weighing idler roller is intentionally designed to look like a standard idler roller as used in a conventional conveyer belt weigh system. This allows for straight forward swapping of a known conventional idler roller for the weighing idler roller.

Control software can be provided for control and measurement aspects provided by the weighing idler roller. An operator interface can be provided, for example as an application provided on a smart device or a personal computer. A user can use the application to wirelessly interface with the control and measurement devices of the weighing idler roller. Multiple weighing idler rollers can be part of a network which effectively act together as a single belt weigher.

The weighing idler roller can detect whether it is acting as a middle or base roller or as a wing roller. The inclination of the conveyer belt can also be measured and compensated for. If a weighing idler roller is acting as a wing roller the effective weight measured by the weighing idler roller can be calculated as a function of the wing angle. Detection of whether the weighing idler roller is in a wing position or a middle or base position can be achieved by use of the three-axis accelerometer provided internal to the weighing idler roller.

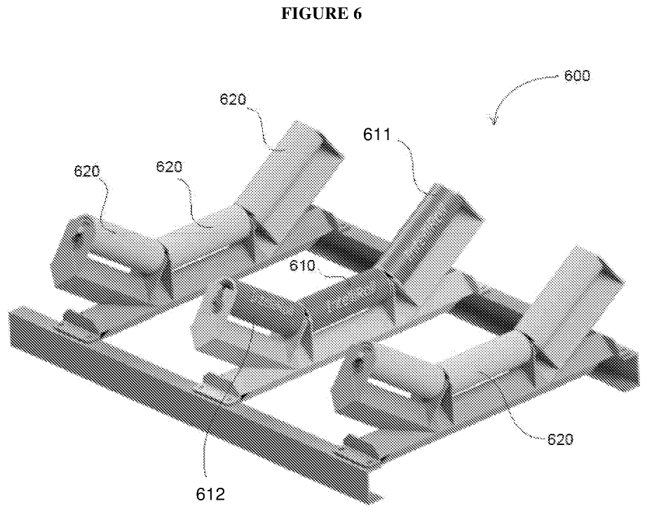

When multiple weighing idler rollers are applied together (refer to FIGS. 6, 7, and 8) the weighing idler rollers can communicate to a selected master weighing roller via a digital radio network, such as using XBee™ radio modules (based on the IEEE 802.15.4 2003 standard designed for point-to-point and star communications). Individual weighing idler rollers can carry out real-time belt weigher processes. The master weighing idler roller 610 accumulates and consolidates the weigh results from all of the weighing idler rollers, including master weighing idler roller 610, wing weighing idler roller 611, and wing weighing idler roller 612, to produce a single belt scale entity. In this arrangement, any of the weighing idler rollers in the group can be set to act as the master weighing idler roller. Groups of weighing idler rollers can be configured on-site, for example using an application on a smart phone to wirelessly communicate with a weighing idler roller. In such a configuration, in one example the master weighing idler roller 610 only has its Wi-Fi interface enabled. The group of weighing idler rollers thus has a single access point and Wi-Fi interface and multiple XBee™ radio module interfaces. A star network can be utilised with one idler roller designated as the master or coordinator weighing idler roller for the star network, for example master weighing idler roller 610.

Thus, in an embodiment there is provided an idler roller that transmits information over an internally generated wireless network. In another embodiment there is an idler roller that transmits information to an external wireless network.

In an example embodiment having no external wires if the roller shell is made of metal the Wi-Fi transmission would be restricted. Thus, in one example the roller shell is made from a high impact plastic material or composite material, which is transparent to electromagnetic waves. This allows the Wi-Fi transmitter/receiver to communicate with transmitters/receivers at some distance from the weighing idler roller.

In another example embodiment there is provided an idler roller, for a conveyor belt weighing system, which comprises a static shaft and two load cells fixed to the static shaft.

Each one of the two load cells (i.e. a first load cell and a second load cell) separately produces an analogue signal, and each one of the two load cells is connected to an analogue to digital converter, which could be a common analogue to digital converter or separate analogue to digital converters. The analogue to digital converter(s) produces a digital output representing the analogue signal from the two load cells.

The digital output of the analogue to digital converter(s) can be zero adjusted by digital computation, for example provided by a digital processor or a software procedure. The digital output of the analogue to digital converter(s) can be used to compute a span calibration to a standard. Preferably, though not necessarily, digital computation is used to eliminate a requirement for use of passive components to balance a Wheatstone bridge.

In another example embodiment there is provided a plurality of idler rollers for a conveyor belt weighing system, comprising at least a first idler roller and at least a second idler roller. The plurality of idler rollers wirelessly communicate and/or optically communicate to each other to form a cluster of active idler rollers, which can act as one device, for example the previously described group of weighing idler rollers.

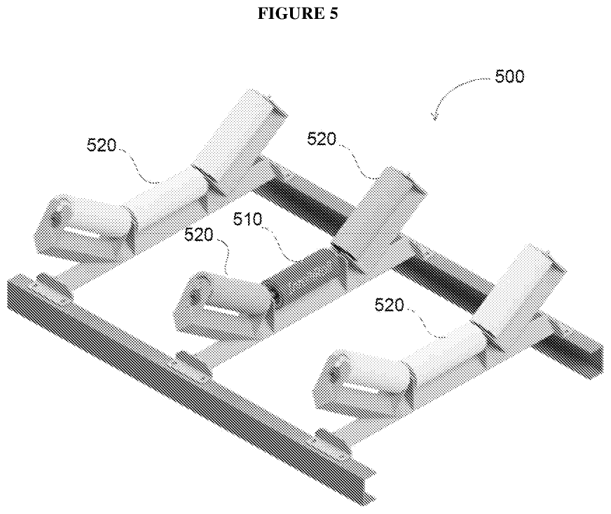

Referring to FIG. 5 there is illustrated a section of a conveyer belt weighing system 500. Weighing idler roller 510 is provided as a middle idler roller and all other idler rollers are conventional (non-weighing) idler rollers 520 as are known in the prior art and which simply support the conveyer belt. Thus, in one example implementation, a single weighing idler roller can be provided as a base or central roller.

Referring to FIG. 6 there is illustrated a section of another example conveyer belt weighing system 600. In this example master weighing idler roller 610 is provided as a base or central roller in addition to wing weighing idler rollers 611, 612 being provided, as illustrated. Conventional (non-weighing) idler rollers 620 are provided at other locations along the conveyer belt.

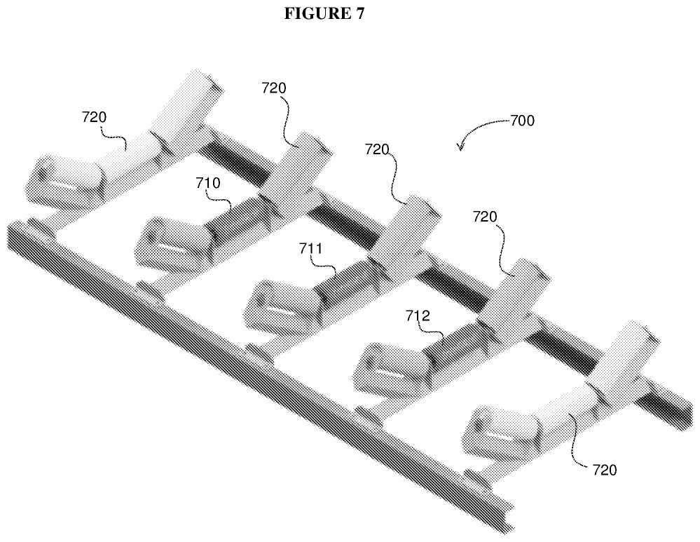

Referring to FIG. 7 there is provided a section of another example conveyer belt weighing system 700. In this example first weighing idler roller 710, second weighing idler roller 711, and third weighing idler roller 712 are provided as a plurality of base or central idler rollers. Other base or central idler rollers 720 are provided as conventional (non-weighing) idler rollers, and wing idler rollers 720 are also conventional (non-weighing) idler rollers. The number of weighing idler rollers that are provided as different base or central rollers can be varied depending on the implementation desired, for example, one, two, three, four, five, etc., base or central weighing idler rollers can be used.

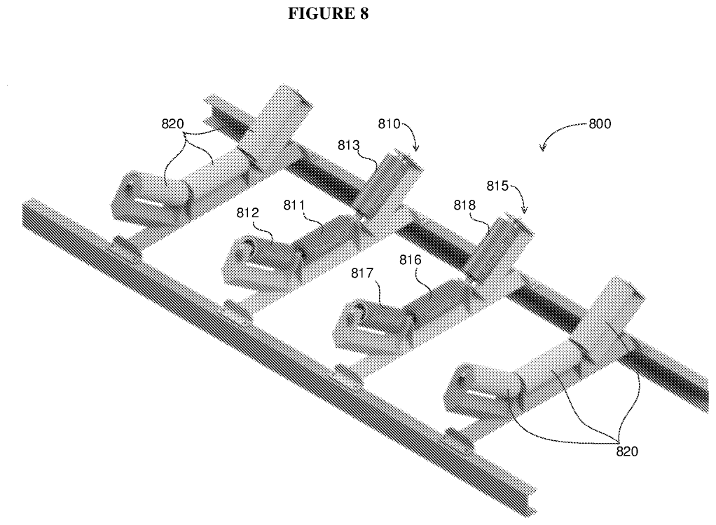

Referring to FIG. 8 there is illustrated a section of another example conveyer belt weighing system 800. In this example sets of weighing idler rollers can be provided as multiple sets of base or central idler rollers and associated wing idler rollers. First set of weighing idler rollers 810 and second set of weighing idler rollers 815 are illustrated. First set of weighing idler rollers 810 includes master weighing idler roller 811, provided as a base or central roller, in addition to wing slave weighing idler rollers 812, 813. Second set of weighing idler rollers 815 includes a slave weighing idler roller 816, provided as a base or central roller, in addition to wing slave weighing idler rollers 817, 818. As illustrated, two sets of weighing idler rollers 810, 815 are provided, however it should be realised that one, two, three, four, five, etc., sets of weighing idler rollers can be provided. Conventional (non-weighing) idler rollers 820 are used as normal at other locations along the conveyer belt. Using a plurality of weighing rollers seeks to increase the signal to noise performance of the weighing computations.

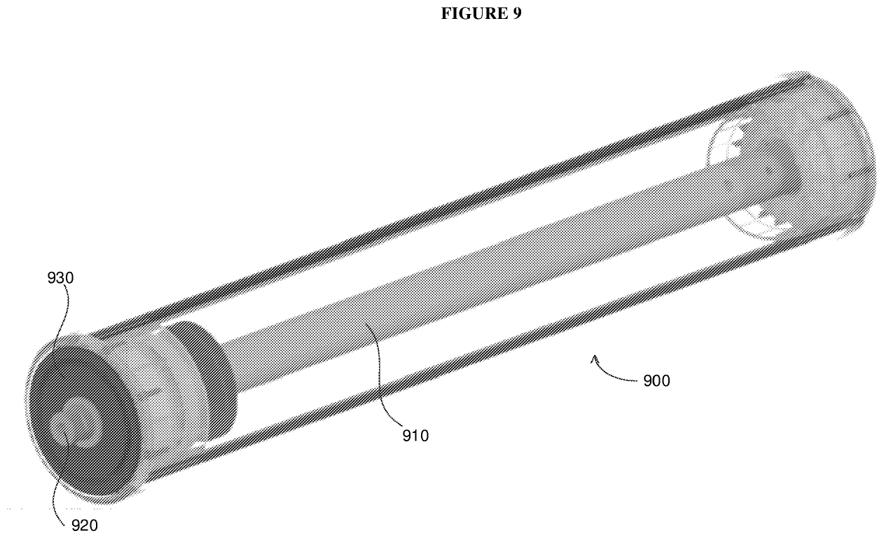

FIG. 9 illustrates a further example of a weighing idler roller 900 in which the roller shell is removed to illustrate the internal configuration of weighing idler roller 900. Static shaft 910 extends along the longitudinal length of weighing idler roller 900. An end of load cell 920 extends through and out of end plate 930. Load cells 920 are provided at both ends of weighing idler roller 900 and attach to the frame, or sub-frame, of a conveyer belt weighing system.

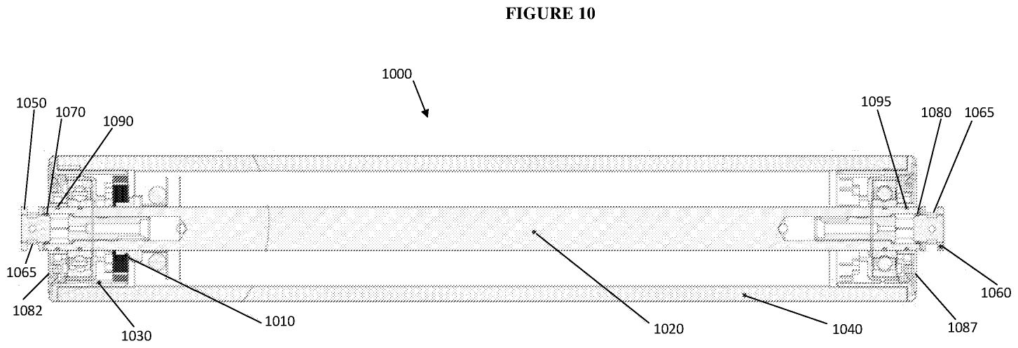

FIG. 10 illustrates a further example of a weighing idler roller 1000. A longitudinal cross section plan view of weighing idler roller 1000 is illustrated and includes generator assembly 1010, shaft 1020, and bearing housing assembly 1030 which is provided at both ends of weighing idler roll 1000 and in one example may be made of a plastic or polymer material or materials. Weighing idler roller 1000 also includes roller shell 1040, for example being made of a plastic or polymer material or materials. First load cell 1050 is provided at one end of weighing idler roller 1000, and second load cell 1060 is provided at the opposite end of weighing idler roller 1000. First load cell 1050 and second load cell 1060 each include a shaft finger adapter 1065 at a distal end to facilitate attachment and fixing of weighing idler roller 1000 at both ends to a frame, or sub-frame, of a conveyer belt weighing system.

A first static seal 1070 is provided between an exterior surface of first load cell 1050 and an interior surface of a first end of static shaft 1020, and a second static seal 1080 is provided between an exterior surface of second load cell 1060 and an interior surface of a second end of static shaft 1020. The length and diameter of weighing idler roller 1000 can be varied depending on the application and physical dimensions of the conveyor belt weighing system.

In a non-limiting example, each end of weighing idler roller 1000 can be sealed with a labyrinth shaft seal that is provided abutting against the exterior surface of shaft 1020 and extending to bearing housing assembly 1030 provided at each end of weighing idler roller 1000. First labyrinth shaft seal 1082 and second labyrinth shaft seal 1087 provide end sealing arrangements for each end of weighing idler roller 1000. A first rotating shaft seal 1090 is positioned between a first labyrinth shaft seal 1082 and the exterior surface of shaft 1020. A second rotating shaft seal 1095 is positioned between a second labyrinth shaft seal 1087 and the exterior surface of shaft 1020.

Currently, the industry accepted belt sag is approximately 2% of the idler spacing. Industry accepted standards use a variety of design spacings depending upon belt loading and belt tension as required to achieve acceptable belt sag of approximately 2%. The spacing of idlers is generally for economical reasons, and often 1.5 m spacing is used to reduce the number of idlers required for conveyors carrying relatively light materials such as coal; and 1.0 m spacing is also often used for conveyors carrying heavy materials such as minerals.

In another example, material movement on a belt could be reduced by provision of a thicker belt. Thickness of belts varies between particular conveyor belt installations. Often, a 20 mm thickness is used for a 1.0 m wide belt, or a 35 mm thickness is used for a 2.0 m wide belt. By providing belts of relatively greater thickness less disturbance forces are transmitted to conveyed material at the idlers/rollers, which results in less material bounce and thus less relative material movement on the belt or other non-linear dynamic effects. Additionally or alternatively, the belt surface material and/or composition can be selected to assist in reducing material movement relative to the belt. By providing a belt surface or composition with a relatively greater than typical coefficient of friction the belt surface may better hold the conveyed material in position, thereby reducing material slip on the belt. Protruding structures from the surface of the belt, or indents into the surface of the belt, could be provided to reduce relative movement of the material to the belt surface.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. An idler roller for a conveyor belt weighing system, comprising:
a static shaft;
a load cell fixed to the static shaft and positioned at least partially internal to the static shaft and at an end of the static shaft, the load cell for supporting the idler roller on a frame; and
a rotating shaft seal positioned on an exterior surface of the static shaft and internal to the idler roller.

2. The idler roller of claim 1, further including a static seal positioned between the load cell and an interior surface of the static shaft.

3. The idler roller of claim 1, wherein the static shaft includes a first pocket into which the load cell is inserted and fixed.

4. The idler roller of claim 3, wherein the static shaft also includes a second pocket into which the load cell is inserted and fixed.

5. The idler roller of claim 1, wherein the load cell includes one or more strain gauges.

6. The idler roller of claim 1, wherein the load cell is rigidly fixed in the end of the static shaft.

7. The idler roller of claim 3, wherein the rotating shaft seal is positioned within the longitudinal extent of first pocket.

8. The idler roller of claim 1, wherein the rotating shaft seal is positioned within a longitudinal extent of a waist section of a body of the load cell.

9. The idler roller of claim 2, wherein the static seal is positioned outside a longitudinal extent of a waist section of a body of the load cell.

10. The idler roller of claim 2, wherein the static seal is positioned closer to an end of the static shaft than the rotating shaft seal.

11. The idler roller of claim 1, wherein a roller shell is rotatable about the static shaft.

12. The idler roller of claim 1, wherein an electronics board is positioned internal to the idler roller and takes readings from the one or more strain gauges.

13. The idler roller of claim 5, wherein the one or more strain gauges are located internal to the static shaft.

14. The idler roller of claim 1, wherein a permanent magnet generator is internal to the idler roller and fixed to the static shaft.

15. The idler roller of claim 1, further including a second load cell fixed to the static shaft and positioned at least partially internal to the static shaft and at an opposite end of the static shaft to the load cell, the second load cell also supporting the idler roller on the frame.

16. A conveyor belt weighing system, comprising:
one or more idler rollers according to claim 1;
a plurality of standard idler rollers;
a frame supporting the one or more idler rollers and the plurality of standard idler rollers; and
a conveyor belt supported by the one or more idler rollers and the plurality of standard idler rollers.

17. An idler roller for a conveyor belt weighing system, comprising:
a static shaft; and
two load cells fixed to the static shaft;
wherein each of the two load cells produces an analogue signal and is connected to an analogue to digital converter that produces a digital output representing the analogue signal.

18. The idler roller of claim 17, wherein the digital output of the analogue to digital converter is zero adjusted by digital computation.

19. The idler roller of claim 17, wherein the digital output of the analogue to digital converter is used to compute a span calibration to a standard.

20. The idler roller of claim 17, wherein digital computation is used to eliminate a requirement for use of passive components to balance a Wheatstone bridge.

21. (canceled)

22. (canceled)

23. (canceled)

24. (canceled)

25. (canceled)
